(19) United States
(12) Patent Application Publication
(10) Pub. No.: US 2026/0164450 A1
(43) Pub. Date: Jun. 11, 2026

(54) PDCCH MAPPING

(71) Applicant: Nokia Technologies Oy, Espoo (FI)

(72) Inventors: Jing Yuan SUN, Beijing (CN); Claudio ROSA, Aalborg (DK); Guillermo POCOVI, Aalborg (DK); Youngsoo YUK, Seoul (KR); Nhat-Quang NHAN, Massy (FR)

(21) Appl. No.: 19/113,571

(22) PCT Filed: Oct. 10, 2022
(86) PCT No.: PCT/CN2022/124461

§ 371 Date: Mar. 20, 2025

(51) Int. Cl. H04W 72/232

(52) U.S. Cl. CPC H04W 72/232

(57) ABSTRACT

Embodiments of the present disclosure relate to method of PDCCH mapping in SBFD slot. A network device determines validity of resources associated with a plurality of physical downlink control channel (PDCCH) candidates, and transmits, to a terminal device, a PDCCH transmission on at least one PDCCH candidate with valid resources among the plurality of PDCCH candidates. The terminal device determines validity of resources associated with a plurality of PDCCH candidates and performs blind detection of PDCCH on a set of PDCCH candidates with valid resources among the plurality of PDCCH candidates. The solution enables the PDCCH channel estimation/detection is with high efficiency without any waste.

### FIELD

Various example embodiments relate to the field of telecommunication and in particular, to methods, devices, apparatuses and a computer readable medium for PDCCH mapping.

### BACKGROUND

In the communications area, there is a constant evolution ongoing in order to provide efficient and reliable solutions for utilizing wireless communication networks. To meet the demand for wireless data traffic having increased since deployment of 4th generation (4G) communication systems, efforts have been made to develop an improved 5th generation (5G) or pre-5G communication system. The new communication systems can support various types of service applications for terminal devices.

3GPP 5G NR currently supports two duplexing modes: FDD for paired bands and TDD for unpaired bands. In TDD, the time domain resource is split between downlink and uplink. Allocation of limited time duration for the uplink in TDD would result in reduced coverage, increased latency, and reduced capacity. 3GPP has agreed to initiate a Rel-18 study item (RP-213591) on the evolution of duplexing operation in NR. One of the objectives of the study item is to allow simultaneous DL and UL transmission on different physical resource blocks (PRBs)/subbands within an unpaired wideband NR cell, this may be referred as subband non-overlapping full duplex (SBFD).

### SUMMARY

In general, example embodiments of the present disclosure provide a solution for PDCCH mapping.

In a first aspect, there is provided a terminal device. The terminal device comprises at least one processor and at least one memory storing instructions. The instructions, when executed by the at least one processor, cause the terminal device at least to: determine validity of resources associated with a plurality of physical downlink control channel (PDCCH) candidates; and perform blind detection of PDCCH on a set of PDCCH candidates with valid resources among the plurality of PDCCH candidates.

In a second aspect, there is provided a network device. The network device comprises at least one processor; and at least one memory storing instructions. The instructions, when executed by the at least one processor, cause the access network device at least to: determine validity of resources associated with a plurality of physical downlink control channel (PDCCH) candidates; and transmit, to a terminal device, a PDCCH transmission on at least one PDCCH candidate with valid resources among the plurality of PDCCH candidates.

In a third aspect, there is provided a method. The method implemented at a terminal device. The method comprises determining, at a terminal device, validity of resources associated with a plurality of physical downlink control channel (PDCCH) candidates; and performing blind detection of PDCCH on a set of PDCCH candidates with valid resources among the plurality of PDCCH candidates.

In a fourth aspect, there is provided a method. The method implemented at a network device. The method comprises determining, at a network device, validity of resources associated with a plurality of physical downlink control channel (PDCCH) candidates; and transmitting, to a terminal device, a PDCCH transmission on at least one PDCCH candidate with valid resources among the plurality of PDCCH candidates.

In a fifth aspect, there is provided an apparatus. The apparatus comprising means for determining, at a terminal device, validity of resources associated with a plurality of physical downlink control channel (PDCCH) candidates; and means for performing blind detection of PDCCH on a set of PDCCH candidates with valid resources among the plurality of PDCCH candidates.

In a sixth aspect, there is provided an apparatus. The apparatus comprising means for determining, at a network device, validity of resources associated with a plurality of physical downlink control channel (PDCCH) candidates; and means for transmitting, to a terminal device, a PDCCH transmission on at least one PDCCH candidate with valid resources among the plurality of PDCCH candidates.

In a seventh aspect, there is provided a non-transitory computer readable medium comprising program instructions for causing an apparatus to perform at least the method according to any one of the above third to fourth aspect.

In an eighth aspect, there is provided a non-transitory computer readable medium comprising program instructions stored thereon for performing at least the method according to any one of the above third to fourth aspect.

In a ninth aspect, there is provided a computer program comprising instructions, which, when executed by an apparatus, cause the apparatus at least to: determine validity of resources associated with a plurality of physical downlink control channel (PDCCH) candidates; and perform blind detection of PDCCH on a set of PDCCH candidates with valid resources among the plurality of PDCCH candidates.

In a tenth aspect, there is provided a computer program comprising instructions, which, when executed by an apparatus, cause the apparatus at least to: determine validity of resources associated with a plurality of physical downlink control channel (PDCCH) candidates; and transmit, to a terminal device, a PDCCH transmission on at least one PDCCH candidate with valid resources among the plurality of PDCCH candidates.

In a eleventh aspect, there is provided a terminal device comprising: determining circuitry configured to determine validity of resources associated with a plurality of physical downlink control channel (PDCCH) candidates; and performing circuitry configured to perform blind detection of PDCCH on a set of PDCCH candidates with valid resources among the plurality of PDCCH candidates.

In a twelfth aspect, there is provided a network device comprising: determining circuitry configured to determine validity of resources associated with a plurality of physical downlink control channel (PDCCH) candidates; and transmitting circuitry configured to transmit, to a terminal device, a PDCCH transmission on at least one PDCCH candidate with valid resources among the plurality of PDCCH candidates.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication system in which embodiments of the present disclosure may be implemented;

FIG. 2 illustrates a schematic diagram illustrating frequency-time resource partitioning with SBFD as compared to FDD and TDD;

FIG. 3 illustrates a schematic diagram illustrating SBFD and non-SBFD slots;

FIG. 4 illustrates another schematic diagram illustrating SBFD and non-SBFD slots;

FIG. 5 illustrates a schematic diagram illustrating a process of communication between a terminal device and a network device;

FIG. 6 illustrates a flowchart illustrating a process for PDCCH mapping according to some embodiments of the present disclosure;

FIG. 7 illustrates a schematic diagram illustrating a method implemented at a terminal device according to some other embodiments of the present disclosure;

FIG. 8 illustrates a schematic diagram illustrating a method implemented at a network device according to some other embodiments of the present disclosure;

FIG. 9 illustrates a simplified block diagram of an apparatus that is suitable for implementing embodiments of the present disclosure; and

FIG. 10 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In communication networks where a number of network devices are jointly deployed in a geographical area to serve respective cells, a terminal device may have an active connection with a network device when being located within the corresponding cell. In the active connection, the terminal device may communicate with that network device on the frequency band in both an uplink (UL) and a downlink (DL). The terminal device may need to switch a link in one direction such as the UL to a further network device due to various reasons such as quality degradation in the UL.

NR PDCCH will be mapped on CCEs (Control channel elements) in configured CORESET (Control resource set), with aggregation level as 1, 2, 4, 8 or 16. For NR UE, CORESET will be configured to UE. As in 38.213, “For each DL BWP (Bandwidth part) configured to a UE in a serving cell, the UE can be provided by higher layer signalling with:
P≤3 CORESETs if coresetPoolIndex is not provided, or if a value of coresetPoolIndex is same for all CORESETs if coresetPoolIndex is provided
P≤5 CORESETs if coresetPoolIndex is not provided for a first CORESET, or is provided and has a value 0 for a first CORESET, and is provided and has a value 1 for a second CORESET”

UE should do blind detection of PDCCH (Physical downlink control channel) in search space within a CORESET. “For each DL BWP configured to a UE in a serving cell, the UE is provided by higher layers with S≤10 search space sets where, for each search space set from the S search space sets, the UE is provided the following by SearchSpace: . . . ”. The number of CORESET is related to the complexity of PDCCH DMRS based channel estimation. The more CORESET to be supported per UE and the larger the CORESET, the more complexity for PDCCH DMRS based channel estimation. That is why the number of CORESET to be supported by UE is limited to 3 or 5 as in the specification.

When doing blind detection of PDCCH, UE will detect PDCCH candidates (can be called as candidates for short) of the PDCCH for aggregation levels in the search space. As defined in specification below.

“For a search space set s associated with CORESET p, the CCE indexes for aggregation level L corresponding to PDCCH candidate

$${m}_{s , {n}_{CI}}^{( L )}$$

of the search space set in
slot

$${n}_{s , f}^{μ}$$

or an active DL BWP of a serving cell corresponding to carrier indicator field value n_{CI} are given by:

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

where for any CSS,

$${Y}_{p , {n}_{s , f}^{μ}} = 0.$$

### For a USS,

$${Y}_{p , {n}_{s , f}^{μ}} = ( {A}_{p} \cdot {Y}_{p , {n}_{s , f}^{μ} - 1} ) mod D ,$$

Y_{p,-1}=N_{RNTI}≠0, Aₚ=39827 for pmod3=0, Aₚ=39829 for pmod3=1, Aₚ=39839 for pmod3=2, and D=65537; i=0, . . . , L−1; N_{CCE,p} is the number of CCEs, numbered from 0 to N_{CCE,p}−1, in CORESET p and, if any, per RB set; n_{CI} is the carrier indicator field value if the UE is configured with a carrier indicator field by CrossCarrierSchedulingConfig for the serving cell on which PDCCH is monitored; otherwise, including for any CSS,

$${n}_{CI} = 0 ; {m}_{s , {n}_{CI}}^{( L )} = 0 , … , {M}_{s , {n}_{CI}}^{( L )} - 1 ,$$

where

$${M}_{s , {n}_{CI}}^{( L )}$$

is the number of PDCCH candidates the UE is configured to monitor for aggregation level L of a search space set s for a serving cell corresponding to n_{CI}; for any CSS,

$${M}_{s , max}^{( L )} = {M}_{s , 0}^{( L )} .$$

### For a USS,

$${M}_{s , max}^{( L )}$$

is the maximum of

$${M}_{s , {n}_{CI}}^{( L )}$$

over all configured n_{CI} values for a CCE aggregation level L of search space set s; the RNTI value used for n_{RNTI} is the C-RNTI.

3GPP 5G NR currently supports two duplexing modes: FDD for paired bands and TDD for unpaired bands. In TDD, the time domain resource is split between downlink and uplink. Allocation of limited time duration for the uplink in TDD would result in reduced coverage, increased latency, and reduced capacity.

Motivated by this, 3GPP has agreed to initiate a Rel-18 study item (RP-213591) on the evolution of duplexing operation in NR that addresses the challenges above. One of the objectives of the study item is to allow simultaneous DL and UL transmission on different physical resource blocks (PRBs)/subbands within an unpaired wideband NR cell, in present disclosure, and this is referred to as subband non-overlapping full duplex (SBFD). Rel-18 study item on duplexing evolution, including subband non-overlapping full duplex (SBFD).

Some of the most relevant objectives of the study item (RP-213591) in the study item description with regards to the present disclosure as below. In this study, the followings are assumed: Duplex enhancement at the gNB side; half duplex operation at the UE side; No restriction on frequency ranges. The detailed objectives are as follows: Study the subband non-overlapping full duplex and potential enhancements on dynamic/flexible TDD (RAN1, RAN4). Identify possible schemes and evaluate their feasibility and performances (RAN1). Study inter-gNB and inter-UE CLI handling and identify solutions to manage them (RAN1). Consider intra-subband CLI and inter-subband CLI in case of the subband non-overlapping full duplex. Study the performance of the identified schemes as well as the impact on legacy operation assuming their co-existence in co-channel and adjacent channels (RAN1). Study the feasibility and impact on RF requirements considering adjacent-channel co-existence with the legacy operation (RAN4). Study the feasibility and impact on RF requirements considering the self-interference, the inter-subband CLI, and the inter-operator CLI at gNB and the inter-subband CLI and inter-operator CLI at UE (RAN4).

In SBFD slots, there will be UL subband covering a contiguous RB sets. These SBFD RBs may overlap with RBs in some CORESETs that are configured to UE.

In some schemes rate matching in PDSCH, for some RBs/REs, when not available for PDSCH transmission, there is one way to provide UE rate matching pattern and PDSCH will not mapped on the RBs/REs. In other schemes, to configure two CORESETs related to one search space, one on SBFD slot and another on non-SBFD slots.

For channel estimation of PDCCH, there is limitation from UE side, as definition in 38.213, as shown in Table 1. Table 1 shows maximum number

$${C}_{PDCCH}^{max , slot , μ}$$

of non-overlapped CCEs per slot for a DL BWP with SCS configuration μ∈{0, 1, 2, 3} for a single serving cell.

TABLE 1

| μ | Maximum number of non-overlapped CCEs per slot and per serving cell ${C}_{PDCCH}^{m ax , slot , μ}$ |
|---|---|
| 0 | 56 |
| 1 | 56 |
| 2 | 48 |
| 3 | 32 |

For number of blind detection of PDCCH, there is also limitation from UE side, as definition in 38.213, as shown in Table 2. Table 2 shows Maximum number

$${M}_{PDCCH}^{max , slot , μ}$$

of monitored PDCCH candidates per slot for a DL BWP with SCS configuration u E {0, 1, 2, 3} for a single serving cell.

| μ | Maximum number of monitored PDCCH candidates per slot and per serving cell ${M}_{PDCCH}^{ma x , slot , μ}$ |
|---|---|
| 0 | 44 |
| 1 | 36 |
| 2 | 22 |
| 3 | 20 |

When the number of detected PDCCH candidate reaches the maximum value or the number of the CCEs for channel estimation reaches the maximum number, the UE will stop the PDCCH blind detection in the slot. To save UE complexity, the CORESET configured to UE may be same for SBFD slots and non-SBFD (normal/legacy) slots, and then when UE do blind detection in the candidates that-overlap with the SBFD UL RBs, the blind detection will be useless as there will be no PDCCH on that candidate and the blind detection will be wasted. This waste of blind detection will cause 1) waste of UE power in blind detection and 2) reducing the chance of scheduling that UE as less chance to map the UE's PDCCH.

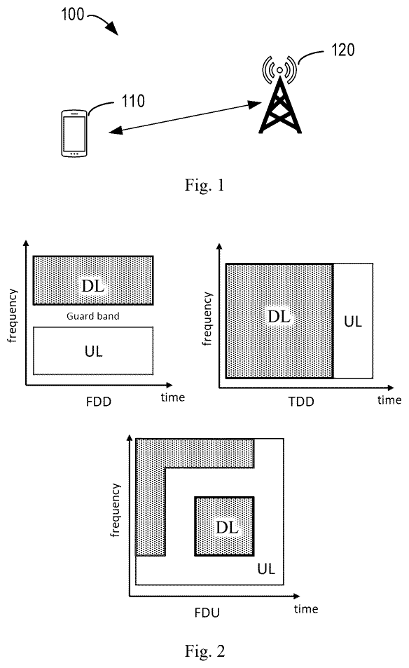

The present disclosure will provide one solution to solve low efficiency issue of PDCCH monitoring as above mentioned. Principle and embodiments of the present disclosure will be described in detail below with reference to the accompanying drawings. Reference is first made to FIG. 1, which illustrates an example communication system 100 in which embodiments of the present disclosure may be implemented. The system 100 includes terminal device 110 and network device 120. The terminal device 110 is capable of connecting and communicating in an UL or DL with the network device 120 as long as the terminal device 110 located within the corresponding cells. In communication systems, an UL refers to a link in a direction from a terminal device 110 to a network device 120, and a DL refers to a link in a direction from the network device 120 to the terminal device 110. The network device 120 can transmit PDCCH to the terminal device 110, and the terminal device 110 can perform blind detection to obtain the corresponding PDCCH.

It is to be understood that the number of network devices 120 and terminal devices 110 is only for the purpose of illustration without suggesting any limitations. The system 100 may include any suitable number of network devices 120 and terminal devices 110 adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As mentioned above, one of the objectives of the 3GPP Rel-18 study item is to allow simultaneous DL and UL transmission on different physical resource blocks (PRBs)/subbands within an unpaired wideband NR cell, as illustrated in FIG. 2. In present disclosure, we refer to this as subband non-overlapping full duplex (SBFD). In other sources, this duplexing scheme is also referred to as cross-division duplexing (xDD) scheme or Flexible Duplexing (FDU). FIG. 2 illustrates a schematic diagram illustrating frequency-time resource partitioning with SBFD as compared to FDD and TDD.

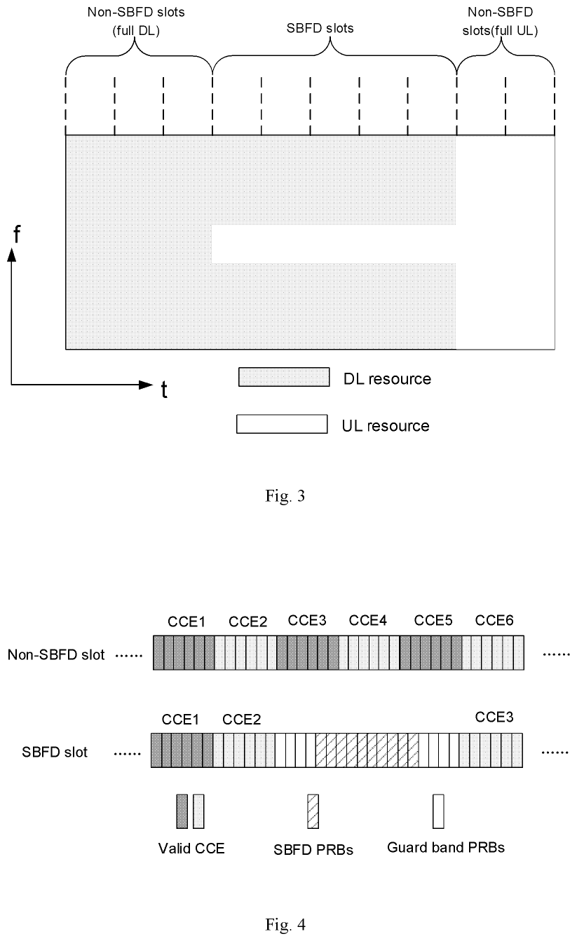

FIG. 3 illustrates a schematic diagram illustrating SBFD and non-SBFD slots. From the above description of SBFD operation, it can be observed that there are two slot types exist for both DL and UL transmissions as shown in FIG. 3, namely SBFD slots, during which the non-overlapping DL subbands and UL subband(s) both exist, and non-SBFD slots, during which the entire band is used for DL or UL (i.e., legacy/full DL/UL slots).

Several SBFD operation modes have been studied including whether time and frequency locations of subbands for SBFD operation are known to the SBFD-aware UE or not. It however has been agreed in 3GPP RAN1 #110 meeting that at least the operation mode with time and frequency locations of subbands for SBFD operation being known to the SBFD-aware UE is prioritized. This means that SBFD slots should be known by the (SBFD-aware) UE in one way or another.

FIG. 4 illustrates another schematic diagram illustrating SBFD and non-SBFD slots. As shown in FIG. 4, for non-SBFD slot, REGs and CCEs will be mapped to all the PRBs in the search space in the CORESET. While for SBFD slot, a plurality of REGs are overlapped with SBFD UL subband or guard band.

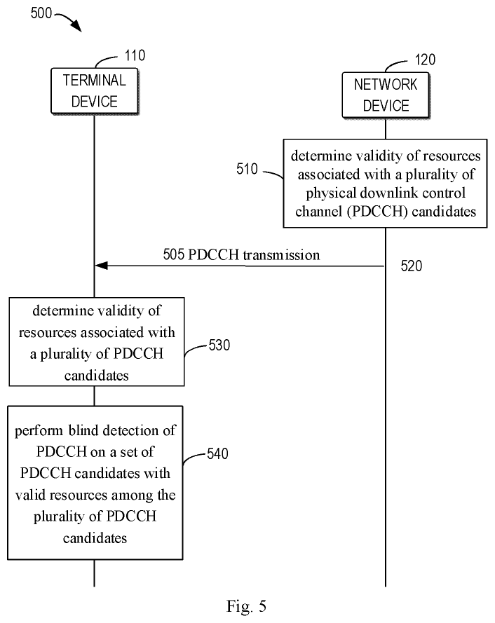

FIG. 5 illustrates a schematic diagram illustrating a process 500 of communication between a terminal device 110 and a network device 120. As shown in FIG. 5, the network device 120 may determine (510) validity of resources associated with a plurality of physical downlink control channel (PDCCH) candidates. The network device 120 may transmit (520), to a terminal device 110, a PDCCH transmission 505 on at least one PDCCH candidate with valid resources among the plurality of PDCCH candidates. On the other side of communication, the terminal device 110 may determine (530) validity of resources associated with a plurality of physical downlink control channel (PDCCH) candidates. The terminal device 110 may perform (540) blind detection of PDCCH on a set of PDCCH candidates with valid resources among the plurality of PDCCH candidates.

In this way, without introducing new CORESET, the number of candidates of PDCCH for blind detection can be not reduced and the PDCCH channel estimation/detection can be with high efficiency without any waste.

In some embodiments, the network device 120 may transmit, to the terminal device 110, a rule for determining the validity of resources associated with the plurality of PDCCH candidates. Accordingly, the terminal device 110 may receive, from the network device 120, the rule for determining the validity of resources associated with the plurality of PDCCH candidates. Thus, the terminal device 110 can perform an operation of determining the validity of resources associated with the plurality of PDCCH candidates based on the rule configured by the network device 120. In this way, the network device 120 can determine the way in which the terminal device 110 determines the validity of resources associated with the plurality of PDCCH candidates.

In some embodiments, the network device 120 may transmit, to the terminal device 110, a first indication of enabling or disabling the rule. Accordingly, the terminal device 110 may receive, from the network device 120, the first indication of enabling or disabling the rule. In this way, the network device 120 can decide whether the terminal device 110 enables or disables the rule. Alternatively, the first indication may be used for activating or deactivating the rule.

In some embodiments, determining validity of resources associated with a plurality of physical downlink control channel (PDCCH) candidates can be performed by the terminal device 110, e.g. based on a pre-defined rule.

In some embodiments, the terminal device 110 may determine the validity of resources associated with the plurality of PDCCH candidates by based on determining that a physical resource block (PRB) associated with a PDCCH candidate among the plurality of PDCCH candidates is invalid, determining that the PDCCH candidate is invalid. In some embodiments, the terminal device 110 may determine the validity of resources associated with the plurality of PDCCH candidates by based on determining that a resource element group (REG) associated with a PDCCH candidate among the plurality of PDCCH candidates is invalid, determining that the PDCCH candidate is invalid. In some embodiments, the terminal device 110 may determine the validity of resources associated with the plurality of PDCCH candidates by based on determining that a control channel element (CCE) associated with a PDCCH candidate among the plurality of PDCCH candidates is invalid, determining that the PDCCH candidate is invalid. In this way, the validity of resources associated with the plurality of PDCCH candidates can be determined based on whether any of PRB, REG or CCE is valid or not.

In some embodiments, the terminal device 110 may determine the validity of resources associated with the plurality of PDCCH candidates by based on determining that all of PRBs associated with the PDCCH candidate are valid, determining that the PDCCH candidate is valid. In some embodiments, the terminal device 110 may determine the validity of resources associated with the plurality of PDCCH candidates by based on determining that all of REGs associated with the PDCCH candidate are valid, determining that the PDCCH candidate is valid. In some embodiments, the terminal device 110 may determine the validity of resources associated with the plurality of PDCCH candidates by based on determining that all of CCEs associated with the PDCCH candidate are valid, determining that the PDCCH candidate is valid. In this way, the validity of resources associated with the plurality of PDCCH candidates can be determined based on whether any of PRB, REG or CCE is invalid or not.

In some embodiments, the terminal device 110 may base on determining that the PRB is not for a PDCCH transmission, determine that the PRB is invalid. In some embodiments, the terminal device 110 may base on determining that all of the PRBs are for a PDCCH transmission, determine that all of the PRBs are valid.

In some embodiments, the terminal device 110 may base on determining that a PRB corresponding to the REG is not for a PDCCH transmission, determine that the REG is invalid. In some embodiments, the terminal device 110 may base on determining that all of PRBs corresponding to all of the REGs are for a PDCCH transmission, determine that all of REGs are valid.

In some embodiments, the terminal device 110 may base on determining that a PRB in the CCE is not for a PDCCH transmission, determine that the CCE is invalid. In some embodiments, the terminal device 110 may base on determining that all of PRBs in all of the CCEs are for a PDCCH transmission, determine that all of CCEs are valid.

In some embodiments, the terminal device 110 may determine the validity of resources associated with the plurality of PDCCH candidates by: receiving, from a network device 120, a second indication of whether a CCE comprising a PRB not for a PDCCH transmission is to be monitored by the terminal device 110; and determining the validity of the plurality of PDCCH candidates based on the second indication.

In some embodiments, the PRB not for a PDCCH transmission may be a PRB for an uplink transmission or a guard band.

In some embodiments, the terminal device 110 may determine the validity of resources associated with the plurality of PDCCH candidates by based on determining that a CCE associated with a PDCCH candidate among the plurality of PDCCH candidates comprises a plurality of REGs on more than one downlink subbands, determining that the CCE is valid or the PDCCH candidate is valid. In other words, the CCE can cover REG on more than one DL subbands.

In some embodiments, the terminal device 110 may determine the validity of resources associated with the plurality of PDCCH candidates by based on determining that the CCE associated with the PDCCH candidate comprises a plurality of REGs on more than one downlink subbands, determining that the CCE is invalid or the PDCCH candidate is invalid. In other words, the CCE can cover REG on only one DL subband.

In some embodiments, the terminal device 110 may determine the validity of resources associated with plurality of PDCCH candidates by based on determining that a PDCCH candidate among the plurality of PDCCH candidates comprises a plurality of CCEs on more than one downlink subbands, determining that the PDCCH candidate is valid. For example, the aggregation of CCE can cover CCEs on more than one DL subbands.

In some embodiments, the terminal device 110 may determine the validity of resources associated with plurality of PDCCH candidates by based on determining that the PDCCH candidate comprises a plurality of CCEs on more than one downlink subbands, determining that the PDCCH candidate is invalid. For example, the aggregation of CCE can cover CCEs on only one DL subband.

In some embodiments, the terminal device 110 may determine the validity of resources associated with plurality of PDCCH candidates by: based on determining that a PDCCH candidate among the plurality of PDCCH candidates comprises a plurality of CCEs in a same downlink subband or in continuous downlink subbands, determining that the PDCCH candidate is valid.

In some embodiments, an index of a REG or a CCE for a PDCCH candidate among the plurality of PDCCH candidates is numbered per downlink subband.

In some embodiments, the terminal device 110 may perform mapping of a plurality of REGs to a plurality of CCEs for a valid PDCCH candidate among the set of valid PDCCH candidates based on interleaved CCE-REG mapping or non-interleaved CCE-REG mapping.

In some embodiments, the terminal device 110 may determine the validity of the plurality of PDCCH candidates by: based on determining that the plurality of PDCCH candidates have at least one predetermined aggregation level, determining the validity of the plurality of PDCCH candidates. For example, only for some of aggregation levels, the operation of one or more embodiments above are performed.

In some embodiments, the terminal device 110 may determine the validity of the plurality of PDCCH candidates by: determining whether the plurality of PDCCH candidates are in a subband full duplex (SBFD) slot; and based on determining that the plurality of PDCCH candidates are in a SBFD slot, determining the validity of the plurality of PDCCH candidates.

In some embodiments, determining validity of resources associated with a plurality of physical downlink control channel (PDCCH) candidates can be performed by the network device 120.

In some embodiments, the network device 120 may determine the validity of resources associated with the plurality of PDCCH candidates by based on determining that a physical resource block (PRB) or a resource element group (REG) or a control channel element (CCE) associated with a PDCCH candidate among the plurality of PDCCH candidates is invalid, determining that the PDCCH candidate is invalid.

In some embodiments, the network device 120 may determine the validity of resources associated with the plurality of PDCCH candidates by based on determining that all of PRBs or all of REGs or all of CCEs associated with the PDCCH candidate are valid, determining that the PDCCH candidate is valid.

In some embodiments, the network device 120 may base on determining that the PRB is not for a PDCCH transmission, determine that the PRB is invalid.

In some embodiments, the network device 120 may base on determining that all of the PRBs are for a PDCCH transmission, determine that all of the PRBs are valid.

In some embodiments, the network device 120 may base on determining that a PRB corresponding to the REG is not for a PDCCH transmission, determine that the REG is invalid.

In some embodiments, the network device 120 may base on determining that all of PRBs corresponding to all of the REGs are for a PDCCH transmission, determine that all of REGs are valid.

In some embodiments, the network device 120 may base on determining that a PRB in the CCE is not for a PDCCH transmission, determine that the CCE is invalid.

In some embodiments, the network device 120 may base on determining that all of PRBs in all of the CCEs are for a PDCCH transmission, determine that all of CCEs are valid.

In some embodiments, the network device 120 may transmit, to the terminal device 110, a second indication of whether a CCE comprising a PRB not for a PDCCH transmission is to be monitored by the terminal device 110.

In some embodiments, the PRB not for a PDCCH transmission is a PRB for an uplink transmission or a guard band.

In some embodiments, the network device 120 may determine the validity of resources associated with the plurality of PDCCH candidates by based on determining that a CCE associated with a PDCCH candidate among the plurality of PDCCH candidates comprises a plurality of REGs on more than one downlink subbands, determining that the CCE is valid or the PDCCH candidate is valid.

In some embodiments, the network device 120 may determine the validity of resources associated with the plurality of PDCCH candidates by based on determining that the CCE associated with the PDCCH candidate comprises a plurality of REGs on more than one downlink subbands, determining that the CCE is invalid or the PDCCH candidate is invalid.

In some embodiments, the network device 120 may determine the validity of resources associated with plurality of PDCCH candidates by based on determining that a PDCCH candidate among the plurality of PDCCH candidates comprises a plurality of CCEs on more than one downlink subbands, determining that the PDCCH candidate is valid.

In some embodiments, the network device 120 may determine the validity of resources associated with plurality of PDCCH candidates by based on determining that the PDCCH candidate comprises a plurality of CCEs on more than one downlink subbands, determining that the PDCCH candidate is invalid.

In some embodiments, the network device 120 may determine the validity of resources associated with plurality of PDCCH candidates by: based on determining that a PDCCH candidate among the plurality of PDCCH candidates comprises a plurality of CCEs in a same downlink subband or in continuous downlink subbands, determining that the PDCCH candidate is valid.

The operation of determining validity of resources associated with a plurality of physical downlink control channel (PDCCH) candidates performed by the network device 120 may refer to the operation of determining validity of resources associated with a plurality of PDCCH candidates performed by the terminal device 110.

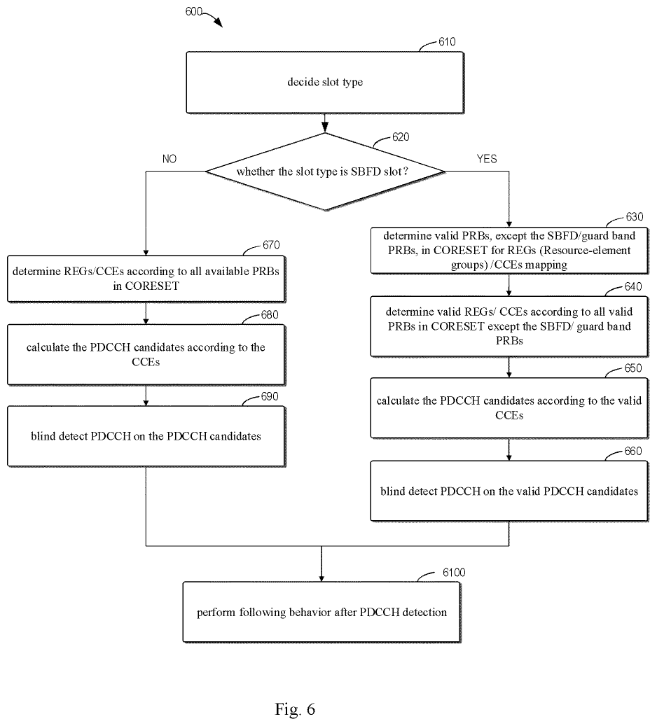

FIG. 6 illustrates a flowchart illustrating a process 600 for PDCCH mapping according to some embodiments of the present disclosure. As shown in FIG. 6, UE may decide slot type (610). The UE may determine whether the slot type is SBFD slot (620). If the slot type is SBFD slot, then the UE may perform steps 630 to 660. If the slot type is not SBFD, then the UE may perform steps 670 to 690. Step 660 or step 690 is followed by step 6100. Specifically, if the slot type is SBFD slot, the UE may determine valid PRBs, except the SBFD/guard band PRBs, in CORESET for REGs (Resource-element groups)/CCEs mapping (630). The UE may determine valid REGs/CCEs according to all valid PRBs in CORESET except the SBFD/guard band PRBs (640). The UE may calculate the PDCCH candidates according to the valid CCEs (650). The UE may blind detect PDCCH on the valid PDCCH candidates (660). If the slot type is not SBFD, the UE may determine REGs/CCEs according to all available PRBs in CORESET (670). The UE may calculate the PDCCH candidates according to the CCEs (680). The UE may blind detect PDCCH on the PDCCH candidates (690). In the step 6100 the UE may perform following behavior after PDCCH detection, and the embodiments of the present disclosure are not limited thereto.

In this way, the present disclosure provides one solution for enhanced PDCCH candidate in SBFD slots, where the PRBs overlapped with the SBFD subband is not counted for candidates of PDCCH for blind detection for all aggregation level and the candidates will be re-organized in SBFD slots other than in non-SBFD slots. With this solution, without introducing new CORESET, the number of candidates of PDCCH for blind detection can be not reduced and the PDCCH channel estimation/detection can be with high efficiency without any waste.

With reference to FIG. 6, in the case where the slot type is SBFD slot, an exemplary flow performed by the UE is as follows: Step 1, when monitoring PDCCH, UE may decide the slot type, as SBFD slot or as non-SBFD slot based on network configuration. Step 2, the UE may determine valid PRBs to map REG/CCEs and calculate the CCEs for valid PDCCH candidates. Step 3, the UE may calculate the PDCCH candidates. Step 4, the UE may do PDCCH monitoring only on the valid PDCCH candidates.

In some embodiments, in SBFD-slot, REG that is overlapped with SBFD UL subband and guard band will not be counted as a valid REG and CCE index is calculated based on available DL PRBs in the search space in the CORESET, where CCE overlapping with one or multiple PRB for SBFD UL subband and guard band will not be counted as a valid CCE.

In some embodiments, the REG index will be calculated according to the available PRBs for PDCCH not overlapping with SBFD related PRB. In some embodiments, the CCE index will be calculated according to the valid CCEs not overlapping with SBFD related PRBs.

In some embodiments, in non-SBFD slot, the UE may calculate the PDCCH candidates based on all the CCEs. In some embodiments, in SBFD slot, the UE may calculate the PDCCH candidates only based on the valid CCEs with valid REGs for all the aggregation level, for both channel estimation of PDCCH and also the PDCCH blind detection.

In some embodiments, the CCE can cover REGs on two DL subband or only on one DL subband.

In some embodiments, the aggregation of CCE can cover CCEs on two DL subband or only on one DL subband.

In some embodiments, the REG/CCE index can be per DL subband and then continue in the next DL subband, instead of mapping for first symbol then next symbol.

In some embodiments, the UE may receive an indication (e.g., via RRC) for indicating whether the CCEs in overlapping resource should be monitored by UE or not.

In some embodiments, interleaved CCE-REG mapping or non-interleaved CCE-REG mapping may be used.

In some embodiments, for a BWP where SBFD will be utilized, where the BWP bandwidth size as e.g. 100 PRBs and SBFD UL subband as 20PRBs with total guard band size as 10PRBs. The SBFD UL subband can be inserted in BWP or at edged of the BWP. When a CORESET is configured to SBFD-aware UE as all the 100 PRBs and 2 symbols. In some embodiment, non-interleaving is used. The PDCCH candidate number for each aggregation level can be e.g. (16, 16, 8, 3, 1). In non-SBFD slots, the available valid REGs for this search space is 100*2=200 REGs. Then all the REGs will be mapped to CCEs, then totally floor (200/6)=33 CCEs available for PDCCH candidates to map/distribute. While in SBFD slots, the available valid REGs for this CORESET is (100−20−10)*2=140 REGs. Then all the REGs will be mapped to CCEs, then totally floor (140/6)=23 CCEs available for PDCCH candidates to map/distribute.

In some embodiments, For non-SBFD slots, the PDCCH candidates may be mapped to the 33 CCEs according to the equation:

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

Where the N_{CCE,p} is 33.

As in non-SBFD slots, all the PRBs are available valid PRBs, all the 44 candidates are valid as for aggregation level AL 1/2/4/8/16, as (16, 16, 8, 3, 1). For SBFD slots, if based on existing method (without the step that determine validity of PDCCH candidates/PRBs/REGs/CCEs), the PDCCH candidates will be mapped to the 33 CCEs according to the equation. Then the PDCCH candidates overlapped with 30 PRBs for the UL subband and guard band will be invalid and not able to map PDCCH. Then the available PDCCH candidates after mapping to the CCEs will be e.g. remaining as (16-a1, 16-a2, 8-a3, 3-a4, 1-a5) and the total reduced PDCCH candidates will be a1+a2+a3+a4+a5, where for different UE with different Y value, the reduced number may be different. The reduced PDCCH candidates will increase the PDCCH blocking probability and the PDCCH may be not able to be transmitted in some of the SBFD slots.

While based on the new solution in present disclosure, the PDCCH candidates related calculation will only consider the valid PRBs, therefore, the PDCCH candidates will be mapped to the 23 CCEs according to the equation, where the N_{CCE,p} is 23. And all the 23 CCEs are available valid CCEs, then all the 44 PDCCH candidates can be valid and no increasing of PDCCH blocking probability. Then UE will do the PDCCH detection based on the calculated PDCCH candidates.

In some embodiments, when considering the valid PDCCH candidates, only the CCEs on the same DL subband or continuous subband where no SBFD subband inserted in, as valid CCEs, and the calculation of the valid PDCCH candidate will consideration this limitation, until the maximum number of UE supported PDCCH candidates are found.

In some embodiments, when considering the valid PDCCH candidates, the CCEs covering REGs on two DL subband are also as valid CCEs, and the calculation of the valid PDCCH candidate will consideration this limitation, until the maximum number of UE supported PDCCH candidates are found.

In some embodiments, only for some of aggregation level, the CCE/REG mapping use the new method (the step that determine validity of PDCCH candidates/PRBs/REGs/CCEs is included, while for other aggregation level, it is allowed to use legacy method (without the step that determine validity of PDCCH candidates/PRBs/REGs/CCEs), based on network control.

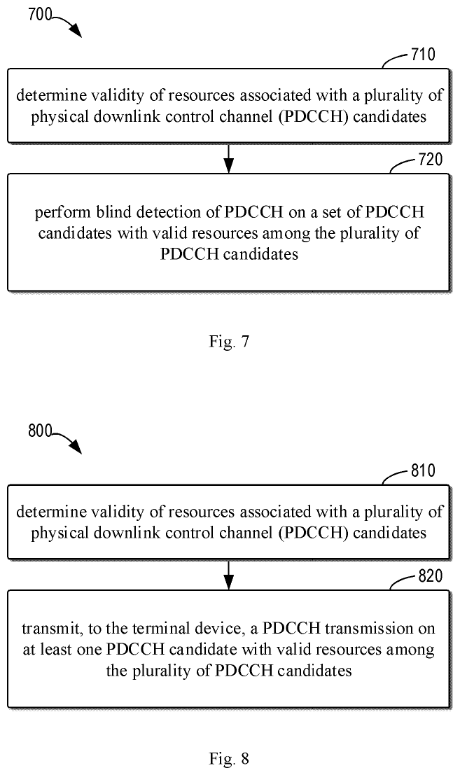

FIG. 7 illustrates a schematic diagram illustrating a method 700 implemented at a terminal device according to some other embodiments of the present disclosure. At block 710, the terminal device 110 may determine validity of resources associated with a plurality of physical downlink control channel (PDCCH) candidates. At block 720, the terminal device 110 may perform blind detection of PDCCH on a set of PDCCH candidates with valid resources among the plurality of PDCCH candidates.

In some embodiments, the terminal device 110 may receive, from the network device 120, a rule for determining the validity of resources associated with the plurality of PDCCH candidates.

In some embodiments, the terminal device 110 may receive, from the network device 120, a first indication of enabling or disabling the rule.

In some embodiments, the terminal device 110 may determine the validity of resources associated with the plurality of PDCCH candidates by at least one of the following: based on determining that a physical resource block (PRB) or a resource element group (REG) or a control channel element (CCE) associated with a PDCCH candidate among the plurality of PDCCH candidates is invalid, determining that the PDCCH candidate is invalid; or based on determining that all of PRBs or all of REGs or all of CCEs associated with the PDCCH candidate are valid, determining that the PDCCH candidate is valid.

In some embodiments, the terminal device 110 may perform at least one of the following: based on determining that the PRB is not for a PDCCH transmission, determine that the PRB is invalid; or based on determining that all of the PRBs are for a PDCCH transmission, determine that all of the PRBs are valid.

In some embodiments, the terminal device 110 may perform at least one of the following: based on determining that a PRB corresponding to the REG is not for a PDCCH transmission, determine that the REG is invalid; or based on determining that all of PRBs corresponding to all of the REGs are for a PDCCH transmission, determine that all of REGs are valid.

In some embodiments, the terminal device 110 may perform at least one of the following: based on determining that a PRB in the CCE is not for a PDCCH transmission, determine that the CCE is invalid; or based on determining that all of PRBs in all of the CCEs are for a PDCCH transmission, determine that all of CCEs are valid.

In some embodiments, the terminal device 110 may determine the validity of resources associated with the plurality of PDCCH candidates by: receiving, from the network device 120, a second indication of whether a CCE comprising a PRB not for a PDCCH transmission is to be monitored by the terminal device 110; and determining the validity of the plurality of PDCCH candidates based on the second indication.

In some embodiments, the PRB not for a PDCCH transmission is a PRB for an uplink transmission or a guard band.

In some embodiments, the terminal device 110 may determine the validity of resources associated with the plurality of PDCCH candidates by one of the following: based on determining that a CCE associated with a PDCCH candidate among the plurality of PDCCH candidates comprises a plurality of REGs on more than one downlink subbands, determining that the CCE is valid or the PDCCH candidate is valid; or based on determining that the CCE associated with the PDCCH candidate comprises a plurality of REGs on more than one downlink subbands, determining that the CCE is invalid or the PDCCH candidate is invalid.

In some embodiments, the terminal device 110 may determine the validity of resources associated with plurality of PDCCH candidates by one of the following: based on determining that a PDCCH candidate among the plurality of PDCCH candidates comprises a plurality of CCEs on more than one downlink subbands, determining that the PDCCH candidate is valid; or based on determining that the PDCCH candidate comprises a plurality of CCEs on more than one downlink subbands, determining that the PDCCH candidate is invalid.

In some embodiments, the terminal device 110 may determine the validity of resources associated with plurality of PDCCH candidates by: based on determining that a PDCCH candidate among the plurality of PDCCH candidates comprises a plurality of CCEs in a same downlink subband or in continuous downlink subbands, determining that the PDCCH candidate is valid.

FIG. 8 illustrates a schematic diagram illustrating a method 800 implemented at a network device 120 according to some other embodiments of the present disclosure. At block 810, the network device 120 may determine validity of resources associated with a plurality of physical downlink control channel (PDCCH) candidates. At block 820, the network device 120 may transmit, to the terminal device 110, a PDCCH transmission on at least one PDCCH candidate with valid resources among the plurality of PDCCH candidates.

In some embodiments, the network device 120 may transmit, to the terminal device 110, a rule for determining the validity of resources associated with the plurality of PDCCH candidates.

In some embodiments, the network device 120 may transmit, to the terminal device 110, a first indication of enabling or disabling the rule.

In some embodiments, the network device 120 may determine the validity of resources associated with the plurality of PDCCH candidates by at least one of the following: based on determining that a physical resource block (PRB) or a resource element group (REG) or a control channel element (CCE) associated with a PDCCH candidate among the plurality of PDCCH candidates is invalid, determining that the PDCCH candidate is invalid; or based on determining that all of PRBs or all of REGs or all of CCEs associated with the PDCCH candidate are valid, determining that the PDCCH candidate is valid.

In some embodiments, the network device 120 may perform at least one of the following: based on determining that the PRB is not for a PDCCH transmission, determine that the PRB is invalid; or based on determining that all of the PRBs are for a PDCCH transmission, determine that all of the PRBs are valid.

In some embodiments, the network device 120 may perform at least one of the following: based on determining that a PRB corresponding to the REG is not for a PDCCH transmission, determine that the REG is invalid; or based on determining that all of PRBs corresponding to all of the REGs are for a PDCCH transmission, determine that all of REGs are valid.

In some embodiments, the network device 120 may perform at least one of the following: based on determining that a PRB in the CCE is not for a PDCCH transmission, determine that the CCE is invalid; or based on determining that all of PRBs in all of the CCEs are for a PDCCH transmission, determine that all of CCEs are valid.

In some embodiments, the network device 120 may transmit, to the terminal device 110, a second indication of whether a CCE comprising a PRB not for a PDCCH transmission is to be monitored by the terminal device 110.

In some embodiments, the PRB not for a PDCCH transmission is a PRB for an uplink transmission or a guard band.

In some embodiments, the network device 120 may determine the validity of resources associated with the plurality of PDCCH candidates by one of the following: based on determining that a CCE associated with a PDCCH candidate among the plurality of PDCCH candidates comprises a plurality of REGs on more than one downlink subbands, determining that the CCE is valid or the PDCCH candidate is valid; or based on determining that the CCE associated with the PDCCH candidate comprises a plurality of REGs on more than one downlink subbands, determining that the CCE is invalid or the PDCCH candidate is invalid.

In some embodiments, the network device 120 may determine the validity of resources associated with plurality of PDCCH candidates by one of the following: based on determining that a PDCCH candidate among the plurality of PDCCH candidates comprises a plurality of CCEs on more than one downlink subbands, determining that the PDCCH candidate is valid; or based on determining that the PDCCH candidate comprises a plurality of CCEs on more than one downlink subbands, determining that the PDCCH candidate is invalid.

In some embodiments, the network device 120 may determine the validity of resources associated with plurality of PDCCH candidates by: based on determining that a PDCCH candidate among the plurality of PDCCH candidates comprises a plurality of CCEs in a same downlink subband or in continuous downlink subbands, determining that the PDCCH candidate is valid.

In some embodiments, an apparatus capable of performing any of the method 700 (for example, the terminal device 110) may comprise means for performing the respective steps of the method 700. The means may be implemented in any suitable form. For example, the means may be implemented in a circuitry or software module.

In some embodiments, the apparatus comprises means for determining validity of resources associated with a plurality of physical downlink control channel (PDCCH) candidates; and means for performing blind detection of PDCCH on a set of PDCCH candidates with valid resources among the plurality of PDCCH candidates.

In some embodiments, the apparatus further comprises means for receiving, from a network device 120, a rule for determining the validity of resources associated with the plurality of PDCCH candidates.

In some embodiments, the apparatus further comprises means for receiving, from the network device 120, a first indication of enabling or disabling the rule.

In some embodiments, the means for determining the validity of resources associated with the plurality of PDCCH candidates comprises at least one of the following: means for based on determining that a physical resource block (PRB) or a resource element group (REG) or a control channel element (CCE) associated with a PDCCH candidate among the plurality of PDCCH candidates is invalid, determining that the PDCCH candidate is invalid; or means for based on determining that all of PRBs or all of REGs or all of CCEs associated with the PDCCH candidate are valid, determining that the PDCCH candidate is valid.

In some embodiments, the apparatus further comprises at least one of the following: means for based on determining that the PRB is not for a PDCCH transmission, determining that the PRB is invalid; or means for based on determining that all of the PRBs are for a PDCCH transmission, determining that all of the PRBs are valid.

In some embodiments, the apparatus further comprises at least one of the following: means for based on determining that a PRB corresponding to the REG is not for a PDCCH transmission, determining that the REG is invalid; or means for based on determining that all of PRBs corresponding to all of the REGs are for a PDCCH transmission, determining that all of REGs are valid.

In some embodiments, the apparatus further comprises at least one of the following: means for based on determining that a PRB in the CCE is not for a PDCCH transmission, determining that the CCE is invalid; or means for based on determining that all of PRBs in all of the CCEs are for a PDCCH transmission, determining that all of CCEs are valid.

In some embodiments, the means for determining the validity of resources associated with the plurality of PDCCH candidates comprises means for receiving, from a network device 120, a second indication of whether a CCE comprising a PRB not for a PDCCH transmission is to be monitored by the terminal device 110; and means for determining the validity of the plurality of PDCCH candidates based on the second indication.

In some embodiments, the PRB not for a PDCCH transmission is a PRB for an uplink transmission or a guard band.

In some embodiments, the means for determining the validity of resources associated with the plurality of PDCCH candidates comprises one of the following: means for based on determining that a CCE associated with a PDCCH candidate among the plurality of PDCCH candidates comprises a plurality of REGs on more than one downlink subbands, determining that the CCE is valid or the PDCCH candidate is valid; or means for based on determining that the CCE associated with the PDCCH candidate comprises a plurality of REGs on more than one downlink subbands, determining that the CCE is invalid or the PDCCH candidate is invalid.

In some embodiments, the means for determining the validity of resources associated with plurality of PDCCH candidates comprises one of the following: means for based on determining that a PDCCH candidate among the plurality of PDCCH candidates comprises a plurality of CCEs on more than one downlink subbands, determining that the PDCCH candidate is valid; or means for based on determining that the PDCCH candidate comprises a plurality of CCEs on more than one downlink subbands, determining that the PDCCH candidate is invalid.

In some embodiments, the means for determining the validity of resources associated with plurality of PDCCH candidates comprises: means for based on determining that a PDCCH candidate among the plurality of PDCCH candidates comprises a plurality of CCEs in a same downlink subband or in continuous downlink subbands, determining that the PDCCH candidate is valid.

In some embodiments, the apparatus further comprises means for performing other steps in some embodiments of the method 700. In some embodiments, the means comprises at least one processor; and at least one memory including computer program code, the at least one memory and computer program code configured to, with the at least one processor, cause the performance of the apparatus.

In some embodiments, an apparatus capable of performing any of the method 800 (for example, the network device 120) may comprise means for performing the respective steps of the method 800. The means may be implemented in any suitable form. For example, the means may be implemented in a circuitry or software module.

In some embodiments, the apparatus comprises: means for determining validity of resources associated with a plurality of physical downlink control channel (PDCCH) candidates; and means for transmitting, to a terminal device 110, a PDCCH transmission on at least one PDCCH candidate with valid resources among the plurality of PDCCH candidates.

In some embodiments, the apparatus further comprises means for transmitting, to a terminal device 110, a rule for determining the validity of resources associated with the plurality of PDCCH candidates.

In some embodiments, the apparatus further comprises means for transmitting, to a terminal device 110, a first indication of enabling or disabling the rule.

In some embodiments, the means for determining the validity of resources associated with the plurality of PDCCH candidates comprises at least one of the following: means for based on determining that a physical resource block (PRB) or a resource element group (REG) or a control channel element (CCE) associated with a PDCCH candidate among the plurality of PDCCH candidates is invalid, determining that the PDCCH candidate is invalid; or means for based on determining that all of PRBs or all of REGs or all of CCEs associated with the PDCCH candidate are valid, determining that the PDCCH candidate is valid.

In some embodiments, the apparatus further comprises at least one of the following: means for based on determining that the PRB is not for a PDCCH transmission, determining that the PRB is invalid; or means for based on determining that all of the PRBs are for a PDCCH transmission, determining that all of the PRBs are valid.

In some embodiments, the apparatus further comprises at least one of the following: means for based on determining that a PRB corresponding to the REG is not for a PDCCH transmission, determining that the REG is invalid; or means for based on determining that all of PRBs corresponding to all of the REGs are for a PDCCH transmission, determining that all of REGs are valid.

In some embodiments, the apparatus further comprises at least one of the following: means for based on determining that a PRB in the CCE is not for a PDCCH transmission, determining that the CCE is invalid; or means for based on determining that all of PRBs in all of the CCEs are for a PDCCH transmission, determining that all of CCEs are valid.

In some embodiments, the apparatus further comprises means for transmitting, to the terminal device 110, a second indication of whether a CCE comprising a PRB not for a PDCCH transmission is to be monitored by the terminal device 110.

In some embodiments, the PRB not for a PDCCH transmission is a PRB for an uplink transmission or a guard band.

In some embodiments, the means for determining the validity of resources associated with the plurality of PDCCH candidates comprises one of the following: means for based on determining that a CCE associated with a PDCCH candidate among the plurality of PDCCH candidates comprises a plurality of REGs on more than one downlink subbands, determining that the CCE is valid or the PDCCH candidate is valid; or means for based on determining that the CCE associated with the PDCCH candidate comprises a plurality of REGs on more than one downlink subbands, determining that the CCE is invalid or the PDCCH candidate is invalid.

In some embodiments, the means for determining the validity of resources associated with plurality of PDCCH candidates comprises one of the following: means for based on determining that a PDCCH candidate among the plurality of PDCCH candidates comprises a plurality of CCEs on more than one downlink subbands, determining that the PDCCH candidate is valid; or means for based on determining that the PDCCH candidate comprises a plurality of CCEs on more than one downlink subbands, determining that the PDCCH candidate is invalid.

In some embodiments, the means for determining validity of resources associated with the plurality of PDCCH candidates comprises means for based on determining that a PDCCH candidate among the plurality of PDCCH candidates comprises a plurality of CCEs in a same downlink subband or in continuous downlink subbands, determining that the PDCCH candidate is valid.

In some embodiments, the apparatus further comprises means for performing other steps in some embodiments of the method 800. In some embodiments, the means comprises at least one processor; and at least one memory including computer program code, the at least one memory and computer program code configured to, with the at least one processor, cause the performance of the apparatus.

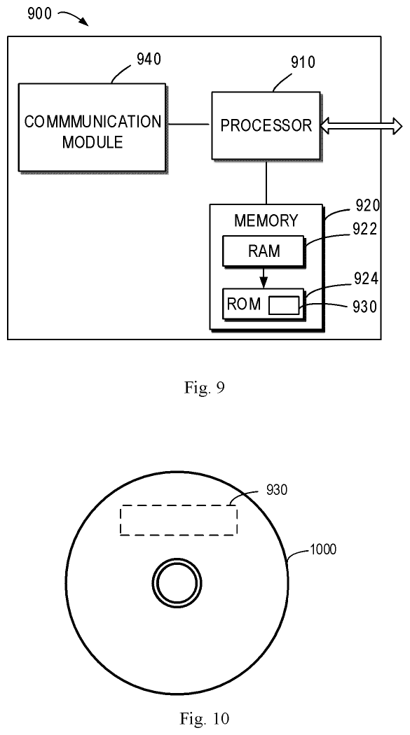

FIG. 9 is a simplified block diagram of a device 900 that is suitable for implementing embodiments of the present disclosure. The device 900 may be provided to implement the communication device, for example the terminal device 110, the network device 120 or the network device 120 as shown in FIG. 1. As shown, the device 900 includes one or more processors 910, one or more memories 940 coupled to the processor 910, and one or more transmitters and/or receivers (TX/RX) 940 coupled to the processor 910.

The TX/RX 940 is for bidirectional communications. The TX/RX 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 1020. The processor 910 may perform any suitable actions and processing by loading the program 930 into the RAM 1020.

The embodiments of the present disclosure may be implemented by means of the program 930 so that the device 900 may perform any process of the disclosure as discussed with reference to FIGS. 2 to 8. The embodiments of the present disclosure may also be implemented by hardware or by a combination of software and hardware.

In some embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 in form of CD or DVD. The computer readable medium has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 700 or the method 800 as described above with reference to FIGS. 2-8. Generally, program modules include routines, programs, libraries, objects, classes, components, data structures, or the like that perform particular tasks or implement particular abstract data types. The functionality of the program modules may be combined or split between program n modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-26. (canceled)

27. A terminal device comprising:
at least one processor; and
at least one memory storing instructions that, when executed by the at least one processor, cause the terminal device at least to:
determine validity of resources associated with a plurality of physical downlink control channel (PDCCH) candidates; and
perform blind detection of PDCCH on a set of PDCCH candidates with valid resources among the plurality of PDCCH candidates.

28. The terminal device of claim 27, wherein the terminal device is further caused to:
receive, from a network device, a rule for determining the validity of resources associated with the plurality of PDCCH candidates.

29. The terminal device of claim 28, wherein the terminal device is further caused to:
receive, from the network device, a first indication of enabling or disabling the rule.

30. The terminal device of claim 27, wherein the terminal device is caused to determine the validity of resources associated with the plurality of PDCCH candidates by at least one of the following:
based on determining that a physical resource block (PRB) or a resource element group (REG) or a control channel element (CCE) associated with a PDCCH candidate among the plurality of PDCCH candidates is invalid, determining that the PDCCH candidate is invalid; or
based on determining that all of PRBs or all of REGs or all of CCEs associated with the PDCCH candidate are valid, determining that the PDCCH candidate is valid.

31. The terminal device of claim 30, wherein the terminal device is further caused to at least one of the following:
based on determining that the PRB is not for a PDCCH transmission, determine that the PRB is invalid; or
based on determining that all of the PRBs are for a PDCCH transmission, determine that all of the PRBs are valid.

32. The terminal device of claim 30, wherein the terminal device is further caused to at least one of the following:
based on determining that a PRB corresponding to the REG is not for a PDCCH transmission, determine that the REG is invalid; or
based on determining that all of PRBs corresponding to all of the REGs are for a PDCCH transmission, determine that all of REGs are valid.

33. The terminal device of claim 30, wherein the terminal device is further caused to at least one of the following:
based on determining that a PRB in the CCE is not for a PDCCH transmission, determine that the CCE is invalid; or
based on determining that all of PRBs in all of the CCEs are for a PDCCH transmission, determine that all of CCEs are valid.

34. The terminal device of claim 27, wherein the terminal device is caused to determine the validity of resources associated with the plurality of PDCCH candidates by:
receiving, from a network device, a second indication of whether a CCE comprising a PRB not for a PDCCH transmission is to be monitored by the terminal device; and
determining the validity of the plurality of PDCCH candidates based on the second indication.

35. The terminal device of claim 31, wherein the PRB not for a PDCCH transmission is a PRB for an uplink transmission or a guard band.

36. The terminal device of claim 27, wherein the terminal device is caused to determine the validity of resources associated with the plurality of PDCCH candidates by one of the following:
based on determining that a CCE associated with a PDCCH candidate among the plurality of PDCCH candidates comprises a plurality of REGs on more than one downlink subbands, determining that the CCE is valid or the PDCCH candidate is valid; or
based on determining that the CCE associated with the PDCCH candidate comprises a plurality of REGs on more than one downlink subbands, determining that the CCE is invalid or the PDCCH candidate is invalid.

37. The terminal device of claim 27, wherein the terminal device is caused to determine the validity of resources associated with plurality of PDCCH candidates by one of the following:
based on determining that a PDCCH candidate among the plurality of PDCCH candidates comprises a plurality of CCEs on more than one downlink subbands, determining that the PDCCH candidate is valid; or
based on determining that the PDCCH candidate comprises a plurality of CCEs on more than one downlink subbands, determining that the PDCCH candidate is invalid.

38. The terminal device of claim 27, wherein the terminal device is caused to determine the validity of resources associated with plurality of PDCCH candidates by:
based on determining that a PDCCH candidate among the plurality of PDCCH candidates comprises a plurality of CCEs in a same downlink subband or in continuous downlink subbands, determining that the PDCCH candidate is valid.

39. A method comprising:
determining, at a terminal device, validity of resources associated with a plurality of physical downlink control channel (PDCCH) candidates; and
performing blind detection of PDCCH on a set of PDCCH candidates with valid resources among the plurality of PDCCH candidates.

40. The method of claim 39, further comprising:
receiving, from a network device, a rule for determining the validity of resources associated with the plurality of PDCCH candidates.

41. The method of claim 40, further comprising
receiving, from the network device, a first indication of enabling or disabling the rule.

42. The method of claim 39, wherein the validity of resources associated with the plurality of PDCCH candidates are determined by at least one of the following:
based on determining that a physical resource block (PRB) or a resource element group (REG) or a control channel element (CCE) associated with a PDCCH candidate among the plurality of PDCCH candidates is invalid, determining that the PDCCH candidate is invalid; or
based on determining that all of PRBs or all of REGs or all of CCEs associated with the PDCCH candidate are valid, determining that the PDCCH candidate is valid.

43. The method of claim 42, further comprising at least one of the following:
based on determining that the PRB is not for a PDCCH transmission, determining that the PRB is invalid; or
based on determining that all of the PRBs are for a PDCCH transmission, determining that all of the PRBs are valid.

44. The method of claim 42, further comprising at least one of the following:
based on determining that a PRB corresponding to the REG is not for a PDCCH transmission, determining that the REG is invalid; or
based on determining that all of PRBs corresponding to all of the REGs are for a PDCCH transmission, determining that all of REGs are valid.

45. The method of claim 42, further comprising at least one of the following:
based on determining that a PRB in the CCE is not for a PDCCH transmission, determine that the CCE is invalid; or
based on determining that all of PRBs in all of the CCEs are for a PDCCH transmission, determine that all of CCEs are valid.

46. A network device comprising:
at least one processor; and
at least one memory storing instructions that, when executed by the at least one processor, cause the network device at least to:
determine validity of resources associated with a plurality of physical downlink control channel (PDCCH) candidates; and
transmit, to a terminal device, a PDCCH transmission on at least one PDCCH candidate with valid resources among the plurality of PDCCH candidates.
